(19) United States
(12) Patent Application Publication
(10) Pub. No.: US 2008/0049429 A1
(43) Pub. Date: Feb. 28, 2008

(54) LIGHT MODULE WITH AT LEAST ONE LIGHT SOURCE AND A REFLECTOR

(75) Inventor: Hans-Joachim SCHMIDT, Ingolstadt (DE)

Correspondence Address: OSRAM SYLVANIA INC, 100 ENDICOTT STREET, DANVERS, MA, 01923, US

(73) Assignee: Patent-Treuhand-Gesellschaft fur electrische Gluhlampen mbH, Munchen (DE)

(21) Appl. No.: 11/846,007

(22) Filed: Aug. 28, 2007

(30) Foreign Application Priority Data
Aug. 28, 2006 (DE) 20 2006 013 194.9

(51) Int. Cl. F21V 9/08

(52) U.S. Cl. 362/293

(57) ABSTRACT

The invention relates to a light module with at least one light source (4) and a reflector (2), which is arranged so as to reflect the light radiation emitted by the light source (4), a colored anodized layer (22) being formed on at least regions of the upper side (21), which is formed so as to reflect the light radiation, of the reflector (2), which anodized layer is in the form of a spectral filter for the light radiation impinging from the light source (4).

### TECHNICAL FIELD

The invention relates to a light module with at least one light source and a reflector, which is arranged so as to reflect the light signals emitted by the light source.

### PRIOR ART

In order to produce colored light, until now virtually exclusively reflector lamps consisting of glass have been used which have been provided with a filter which has been colored throughout at the light exit. For thermal reasons, primarily owing to the restricted thermal loading capacity of the color filter, in this case the quantity of light which can be produced is very restricted and is dependent on the selected color of the filter. The desired effect of an intensive representation of a large number of colors is thereby threatened since the human eye has a very much lower sensitivity, for example, to red or violet light than to yellow or green light.

For light modules with an open aluminum reflector, that is one which is not covered by a diffuser, as is formed, for example, by a light module HALOSPOT® by the Applicant, until now it has not been possible to color the radiation emitted by the light source. In particular, intensive coloring of the light of a halogen incandescent lamp or metal-halide lamp, for example by means of painting or coating the lamp vessel, results in a whole series of technical problems owing to the very high operating temperatures and until now has not been converted for mass production.

### DESCRIPTION OF THE INVENTION

The object of the present invention is therefore to be able to produce colored light, even in the case of a light module without a spectral filter as the cover for the reflector.

This object is achieved by a light module which has the features as claimed in patent claim 1.

A light module according to the invention comprises at least one light source and a reflector, which is arranged so as to reflect the light signals emitted by the light source. A colored anodized layer is formed on at least regions of the upper side, which is oriented towards the light source and which is formed so as to reflect the light radiation, of the reflector, which anodized layer is in the form of a spectral filter for the radiation impinging from the light source. Owing to this specifically colored upper side of the reflector, a spectral selectivity can be made possible and, as a result, the light radiation impinging from the light source can be filtered in a corresponding manner. Owing to this configuration of the reflector, light radiation reflected on it can be produced in a color-specific manner with very high intensity and saturation. In particular in the case of light modules which do not have a transparent color filter cover on the front side of the reflector and therefore also do not have a diffuser as the filter, the production of colored light can therefore be made possible in a simple manner with little complexity. Coloring the anodized layer is understood to mean imparting a specific color on this layer which is different than the natural, naturally colored form of this material of the anodized layer which is referred to as colorless. Coloring of the anodized layer is therefore understood to mean all processes and/or material additions which result in a colored form which is different than the natural coloring of the material of the anodized layer and with which individual spectral filtering of the radiation spectrum of the light source is made possible.

Preferably, the reflector comprises a color-anodized aluminum sheet. As a result, a sufficiently high spectral selectivity can be made possible.

Preferably, the anodized layer is colored by at least one dye. The processes known for this purpose can be used as the basis for this coloring during anodization. For example, a fresh and porously treated layer can thereby be colored with dyes and then condensation can take place, which generally takes place using hot water or steam. Furthermore, chemical condensation can also take place, which is usually used in combination with steam condensation. Anodized and then colored aluminum can preferably be treated in two-stage sealing processes in order to avoid bleeding of the dyes.

Provision may also be made for at least two subregions of the upper side of the reflector to be formed with a differently colored anodized layer and therefore a different spectral selectivity. The individuality and flexibility of a light module as regards its use can thereby be increased. Such a configuration with at least two parts can be achieved, for example, by virtue of the fact that two subregions, which are provided with differently colored anodized layers, are combined to form a common reflector. For example, in this case an adhesion or joining technique may be provided. Furthermore, provision may also be made for a reflector (which is already provided) with an upper side to be formed with a first colored anodized layer on an inner zone and with a second anodized layer, which is colored differently than the first anodized layer, on an outer zone.

Preferably, the anodized layer is colored by at least one of the hues violet, blue, green, yellow, orange or red or any desired mixture thereof. For this respective coloring, the corresponding dyes can be introduced. These specific hues allow for a broad spectrum of light production for a wide variety of applications of the light module.

Preferably, at least regions of the light source of the light module are covered by a cap. The cap is positioned onto the light source in particular in the form of a hood and therefore covers the front region of the light source. This configuration makes it possible to achieve a situation in which direct radiation emission from the light source in the main emission direction parallel to the axis of symmetry of the reflector is suppressed and, instead, radiation emitted in this direction can leave the light module only once it has been reflected at least once on the upper side of the reflector.

Preferably, the light module comprises a grip element, which extends over the reflector, in particular in the form of an arc between the front edge region of the reflector. Preferably, provision may be made for the grip element and the cap to be connected to one another, in particular to be designed in one piece. The grip element and the cap may be left as their natural color or may preferably be black with regard to a coloring produced or else may have a coloring which corresponds to the upper side of the reflector.

Preferably, at least regions of the upper side are designed to be lustrous and the upper side can therefore be designed to be highly reflective. The reflective design of the upper side can preferably be produced prior to the anodization.

The light source is preferably in the form of a halogen lamp. In particular, a low-volt halogen incandescent lamp can be provided here. However, the light source may also be in the form of an IRC (infrared coating) halogen lamp. In these lamps, a spectral range in the near-infrared is not emitted, but is used for heating the incandescent filament further, as a result of which the power consumption and therefore the radiation loading of the colored anodized layer on the reflector are reduced. Furthermore, the light source may also be in the form of an HCI lamp (metal-halide lamp with ceramic burner). IRC lamps and HCI lamps have been disclosed by the Applicant.

All the mentioned light sources are available in a plurality of rating classes. For example, there are halogen incandescent lamps with rated powers of 10, 20, 35, 50, 75 and 100 W, IRC lamps with 35, 50 and 65 W and HCI lamps with 20, 39 and 72 W. Owing to the use of light sources having a higher power in reflectors of the colors violet, blue and red and light sources of lower power in reflectors of the colors green, yellow and orange, type series can be formed from light modules of different colors which emit the colored light with approximately the same intensity in terms of sensitivity. This results in a considerable application advantage in that the mentioned hues can be used equivalently in lighting design.

The light module is preferably realized without a cover on the front side of the reflector and therefore in particular also without a diffuser or a front-side spectral filter, which covers the reflector on the light-exit side and is formed as a separate element from the reflector. No spectral filter is therefore arranged on this front side of the reflector either.

### BRIEF DESCRIPTION OF THE DRAWINGS

An exemplary embodiment of the invention will be explained in more detail below with reference to schematic drawings, in which:

FIG. 1 shows a perspective illustration of a light module according to the invention; and

FIG. 2 shows a side view of the illustration in FIG. 1.

### PREFERRED EMBODIMENT OF THE INVENTION

Identical or functionally identical elements are provided with the same reference symbols in the figures.

Light modules having a reflector and a light source arranged centrally in the reflector are known. In these light modules, a reflector consisting of a colorlessly anodized, naturally colored aluminum sheet is used. The halogen incandescent lamp used as the burner is covered towards the light exit by means of a dome, with the result that the radiation emitted by the burner can only leave the light module once it has been reflected at least once on the reflector. Such an embodiment is known from the light module HALOSPOT®.

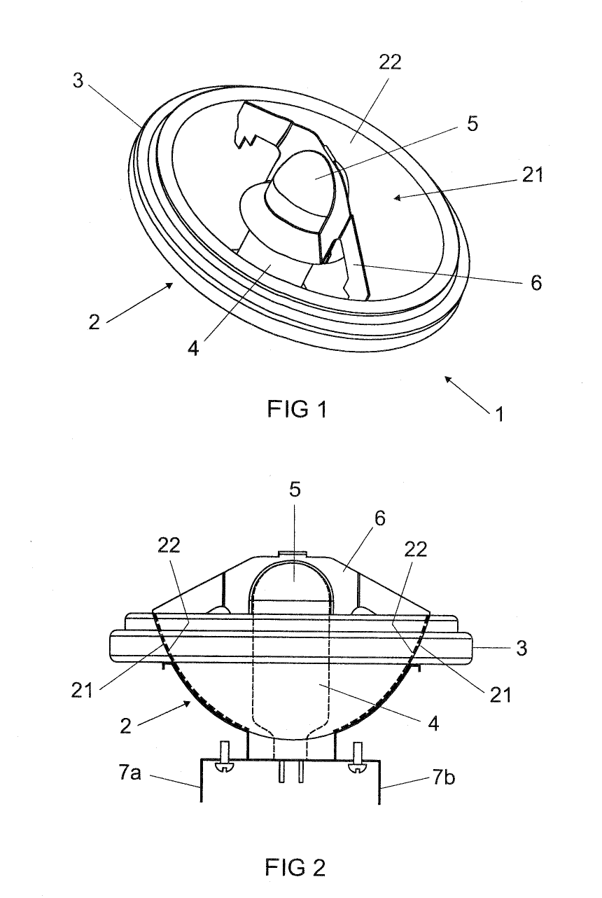

FIG. 1 shows a perspective illustration of a light module 1 according to the invention, which has a reflector 2, which is designed to be rotationally symmetrical and has a funnel-like structure. The reflector 2 is circumferentially surrounded by an edge 3. Arranged centrally in the reflector 2 is a light source 4, which, in the exemplary embodiment, is in the form of a low-volt halogen lamp. This light source 4 is covered on its front side and therefore on the side remote from the use region, in which the light source 4 is used in the reflector 3, by a cap 5. The cap 5 is formed with an arcuate grip web 6 as one piece, which grip web 6 extends over the diameter of the reflector 3 and opens out at an upper side 21 of the reflector 2.

A colored anodized layer 22, which is in the form of a spectral filter for the light signals produced by the light source 4 and impinging on the anodized layer 22, is formed on this upper side 21.

In order to produce colored light by means of the light module 1, the reflector 3 is in the form of a color-anodized aluminum sheet with a spectral selectivity. The colored anodized layer 22 can in this case be colored specifically. Preferably, the anodized layer 22 is colored by at least one dye for producing the hues violet, blue, green, yellow, orange and red or any desired mixture thereof. In each case an intensively colored and a pastel-colored variant are particularly advantageous for proportioning the color effect.

Furthermore, the aluminum sheet, in particular the upper side 21, is advantageously formed with a lustrous surface finish. Provision of this lustrous finish for the aluminum sheet is preferably carried out before the application of the colored anodized layer 22.

The spectral selectivity can be achieved in a cost-effective manner by absorption of the undesired parts of the spectrum. The question of the thermal loading capacity of the reflector 2 acting as the spectral filter with the colored anodized layer 22 and the question of heat dissipation are essential for the maximum convertible light quantity. The reflector 3 can preferably have a diameter of approximately 111 mm and preferably consists of a highly thermally conductive material. Owing to the open construction (no covering disk or diffuser is positioned on the front on the reflector 3), the front side of the light module 1 and in particular the front side of the reflector 3 can also dissipate the heat directly to the surrounding environment. Preferably, provision may also be made for the rear side of the reflector 2 and therefore the side which is remote from the upper side 21 not be covered, with the result that this side can also dissipate the heat very effectively to the surrounding environment. Tests have shown that, even when using burners with a rated power of approximately 100 W over an operating time of approximately 3000 hours, no problems occur even with an anodized layer which is colored black. Since black layers substantially absorb the entire visible spectrum, at least identical results can therefore be achieved with anodized layers 22 which are colored differently since they absorb a much smaller part of the spectrum than such black layers.

In comparison with colored light-emitting diodes with their virtually monochromatic spectrum, the proposed design of the light module 1 with a halogen lamp can allow for a broader-band emission and primarily can allow the possibility for much higher intensities to be produced. Above all, the variants with a pastel-colored reflector 3 can therefore also make a contribution to general lighting to a certain extent. For example, a daylight effect can be produced with a reflector which is colored light blue and therefore an anodized layer 22 which is colored light blue.

FIG. 2 shows a schematic side view of the light module 1. The bell-shaped reflector 2 with its colored anodized layer 22, which is applied over the entire area of the upper side 21, is illustrated. Furthermore, electrical contacts 7a and 7b are shown which are connected to the electrical mains supply for operation of the light module via an electrical transformer or an electronic converter.

1. A light module with at least one light source (4) and a reflector (2), which is arranged so as to reflect the light radiation emitted by the light source (4), characterized in that a colored anodized layer (22) is formed on at least regions of the upper side (21), which is formed so as to reflect the light radiation, of the reflector (2), which anodized layer is in the form of a spectral filter for the light radiation impinging from the light source (4).

2. The light module as claimed in claim 1, characterized in that the reflector (2) has a color-anodized aluminum sheet.

3. The light module as claimed in claim 1, characterized in that the anodized layer (22) is colored by at least one dye.

4. The light module as claimed in claim 1, characterized in that at least two subregions of the upper side (21) with a differently colored anodized layer (22) are formed.

5. The light module as claimed in claim 1, characterized in that the anodized layer (22) is colored by at least one of the hues violet, blue, green, yellow, orange or red or a mixture thereof.

6. The light module as claimed in claim 1, characterized in that the light source (4) is covered by a cap (5) in such a way that the direct radiation emission from the light source in the main emission direction parallel to the axis of symmetry of the reflector (2) is suppressed and, instead, radiation emitted in this direction can leave the light module (1) only once it has been reflected at least once on the reflector (2).

7. The light module as claimed in claim 1, characterized in that a grip web (6) extends over the clear width of the reflector (2), in particular spans the reflector (2) in the form of an arc.

8. The light module as claimed in claim 1, characterized in that at least regions of the upper side (21) are designed to be lustrous.

9. The light module as claimed in claim 1, characterized in that the light source (4) is in the form of a halogen lamp, in particular in the form of a low-volt halogen incandescent lamp or in the form of an IRC halogen lamp or in the form of an HCI lamp.

10. The light module as claimed in claim 1, characterized in that the reflector (2) is open on its front side.
